(19) United States
(12) Patent Application Publication
(10) Pub. No.: US 2022/0355480 A1
(43) Pub. Date: Nov. 10, 2022

(54) CONTROL DEVICE, MOBILE BODY, AND CONTROL METHOD

(71) Applicant: SONY GROUP CORPORATION, TOKYO (JP)

(72) Inventors: SATOKO NAGAKARI, TOKYO (JP); YASUHISA KAMIKAWA, TOKYO (JP); WATARU KOKUBO, TOKYO (JP); ATSUSHI SAKAMOTO, TOKYO (JP)

(21) Appl. No.: 17/753,894

(22) PCT Filed: Sep. 17, 2020
(86) PCT No.: PCT/JP2020/035355

§ 371 Date: Mar. 17, 2022

(30) Foreign Application Priority Data
Sep. 26, 2019 (JP) 2019-175295

(51) Int. Cl. B25J 9/16; B25J 13/00; B25J 19/02; B25J 5/00; B62D 57/028

(52) U.S. Cl. CPC B25J 9/1664; B25J 9/1651; B25J 13/003; B25J 19/023; B25J 5/007; B62D 57/028

(57) ABSTRACT

A control device (10) includes: an acquisition unit (12) that acquires outside-world information (11B) around a mobile body (100); and a control unit (13) that performs control to switch characteristics of a contact portion (130) capable of switching characteristics of a portion where a leg portion of the mobile body (100) comes into contact with an external environment on the basis of the outside-world information (11B) such that a contact sound between the contact portion (130) and the external environment changes.

### FIELD

The present disclosure relates to a control device, a mobile body, and a control method.

### BACKGROUND

A mobile body may include, for example, a body portion and two or more leg portions. Patent Literature 1 discloses a control device that identifies an operation sound of a robot from an input to a voice input unit, and controls an operation of a movable unit so that the operation sound decreases when talking with a human.

### CITATION LIST

### Patent Literature

Patent Literature 1: JP 2006-95635 A

### SUMMARY

### Technical Problem

In the above-described conventional technique, a landing sound of the leg portions is a major problem in a case where a legged mobile robot and a human both live in the same place. For this reason, in the mobile body that moves by the leg portions, it is desired to suppress the landing sound of the leg portions in a case where the mobile body coexists with a human.

Therefore, the present disclosure provides a control device, a mobile body, and a control method capable of changing the landing sound of the leg portions of the mobile body according to an external environment.

### Solution to Problem

To solve the problems described above, a control device according to an embodiment of the present disclosure includes: an acquisition unit that acquires outside-world information around a mobile body; and a control unit that performs control to switch characteristics of a contact portion capable of switching characteristics of a portion where a leg portion of the mobile body comes into contact with an external environment based on the outside-world information such that a contact sound between the contact portion and the external environment changes.

Moreover, a mobile body according to an embodiment of the present disclosure includes: a plurality of leg portions; contact portions provided at portions where the leg portions are in contact with an external environment, the contact portions being switchable between a plurality of characteristics; and a control device that controls the leg portions, wherein the control device includes: an acquisition unit that acquires outside-world information around the mobile body; and a control unit that performs control to switch characteristics of the contact portions based on the outside-world information such that a contact sound between the contact portions and the external environment changes.

Moreover, a control method according to an embodiment of the present disclosure, by a computer, includes: acquiring outside-world information around a mobile body; and performing control to switch characteristics of a contact portion capable of switching characteristics of a portion where a leg portion of the mobile body comes into contact with an external environment based on the outside-world information such that a contact sound between the contact portion and the external environment changes.

### BRIEF DESCRIPTION OF DRAWINGS

FIG. 1 is a perspective view for explaining an example of a mobile body according to a first embodiment.

FIG. 2 is a diagram for explaining an example of an operation of the mobile body according to the first embodiment.

FIG. 3 is a diagram illustrating an example of a configuration of the mobile body according to the first embodiment.

FIG. 4 is a flowchart illustrating an example of a processing procedure executed by a control device according to the first embodiment.

FIG. 5 is a diagram for explaining a relationship between an environmental sound and a landing sound according to the first embodiment.

FIG. 6 is a diagram for explaining a relationship between characteristics of a contact portion and a contact point according to the first embodiment.

FIG. 7 is a view illustrating an example of an operation related to the contact portion of the mobile body according to the first embodiment.

FIG. 8 is a perspective view for explaining an example of a mobile body according to a first modification of the first embodiment.

FIG. 9 is a view for explaining another example of a contact portion of the mobile body according to the first modification of the first embodiment.

FIG. 10 is a diagram for explaining an example of a mobile body according to a second modification of the first embodiment.

FIG. 11 is a diagram for explaining an example of a control device according to a third modification of the first embodiment.

FIG. 12 is a flowchart illustrating an example of a processing procedure executed by a control device according to a second embodiment.

FIG. 13 is a hardware configuration diagram illustrating an example of a computer that implements functions of the control device.

### DESCRIPTION OF EMBODIMENTS

Hereinafter, embodiments of the present disclosure will be described in detail with reference to the drawings. Note that, in each of the following embodiments, the same parts are denoted by the same reference numerals, and redundant description will be omitted.

### First Embodiment

[Outline of Mobile Body According to First Embodiment]

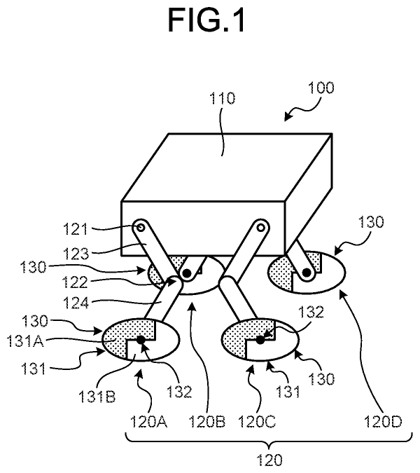

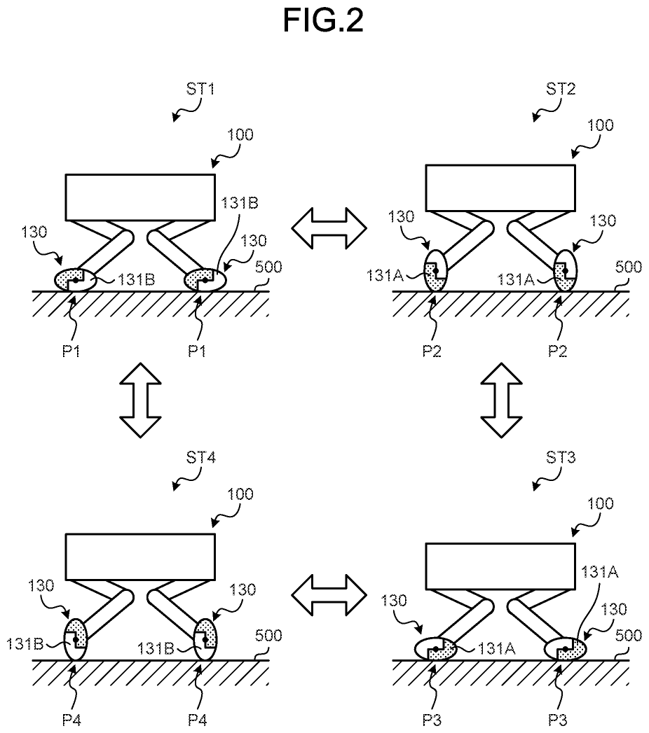

FIG. 1 is a perspective view for explaining an example of a mobile body according to a first embodiment. FIG. 2 is a diagram for explaining an example of an operation of the mobile body according to the first embodiment.

A mobile body 100 illustrated in FIG. 1 is, for example, a robot having a plurality of leg portions 120 and capable of autonomous movement. The mobile body 100 includes a legged mobile robot movable by two or more leg portions 120. Each of the plurality of leg portions 120 includes a contact portion 130 in which the characteristics of portions where the leg portions 120 are in contact with an external environment can be switched. The external environment includes a situation around the mobile body 100, a path on which the mobile body 100 moves, and the like. The external environment includes, for example, a ground, a floor, a staircase, a step, an obstacle, and the like. The mobile body 100 may include, for example, a drone having the leg portions 120 that is movable, a bogie, a vehicle, and the like.

In the example illustrated in FIG. 1, the mobile body 100 includes a main body 110 and four leg portions 120. That is, the mobile body 100 is a mobile robot having four limbs. The main body 110 is, for example, a torso of the mobile body 100. The main body 110 includes, for example, a control device that controls autonomous movement, various sensors, and the like. Furthermore, in the following description, in the description for distinguishing each of the four leg portions 120, the four leg portions 120 will be appropriately referred to as a leg portion 120A, a leg portion 120B, a leg portion 120C, and a leg portion 120D.

The leg portions 120 are portions that protrude from the main body 110, support the main body 110, and are used for movement (walking). The leg portion 120 includes a first joint 121, a second joint 122, a first link 123, a second link 124, and the contact portion 130. In the example illustrated in FIG. 1, the configuration of the leg portion 120 is simplified. Actually, the shape, number, arrangement, and the like of the joints and links can be appropriately set so that the leg portion 120 has a desired degree of freedom.

The first joint 121 and the second joint 122 are provided with, for example, an actuator, and are configured to be rotatable by driving of the actuator. The first link 123 is rotatably provided with respect to the main body 110 by the first joint 121. The second link 124 is rotatably provided with respect to the first link 123 by the second joint 122.

In the first joint 121 and the second joint 122, the driving of the actuator is controlled from the main body 110 to control rotation angles of the first link 123 and the second link 124, thereby controlling the driving of the leg portion 120. As a result, the mobile body 100 controls driving of the leg portion 120A, the leg portion 120B, the leg portion 120C, and the leg portion 120D from the main body 110, thereby realizing movement (walking) by the leg portion 120A, the leg portion 120B, the leg portion 120C, and the leg portion 120D.

The contact portion 130 is provided at a distal end of the leg portion 120 so as to be able to contact the external environment. In the example illustrated in FIG. 1, the contact portion 130 is provided at the distal end of the second link 124 of the leg portion 120. The contact portion 130 includes an elliptical columnar elastic member 131 and a holding mechanism 132 that rotatably holds the elastic member 131.

The elastic member 131 has an elliptical cross section in a longitudinal direction of the main body 110. The elastic member 131 includes a first elastic member 131A and a second elastic member 131B. The first elastic member 131A and the second elastic member 131B are integrally formed such that portions having a large radius of curvature face each other and portions having a small radius of curvature face each other in the longitudinal direction of the main body 110. The elastic member 131 is configured to be rotatable about the holding mechanism 132 in the longitudinal direction of the main body 110. The first elastic member 131A is formed of a member having an elastic modulus higher than that of the second elastic member 131B. The second elastic member 131B is formed of a member having an elastic modulus lower than that of the first elastic member 131A.

The holding mechanism 132 is, for example, a mechanism that rotates the elastic member 131 at a predetermined rotation angle by driving the actuator, and holds the elastic member 131 in a state of being fixed at the rotation angle. For example, the holding mechanism 132 includes a rotation shaft provided along a width direction of the main body 110, and a mechanism that rotatably holds the rotation shaft. In the present embodiment, the holding mechanism 132 is controlled by the main body 110, so that the elastic member 131 can be brought into contact with the external environment at one contact point of a plurality of contact points. The plurality of contact points are points of the elastic member 131 having different contact areas with the external environment.

In the example illustrated in FIG. 2, the mobile body 100 is configured to come into contact with an external environment 500 at any one of the four contact points P1, P2, P3, and P4 of the contact portion 130. That is, the mobile body 100 can bring a desired contact point of the contact portion 130 into contact with the external environment 500 by switching the contact points P1, P2, P3, and P4.

In a state ST1, the mobile body 100 is in contact with the external environment 500 at the contact point P1 of the contact portion 130. The contact point P1 is a portion where a radius of curvature of the second elastic member 131B is small, that is, a portion where a contact area of the second elastic member 131B is large. For example, when the contact portion 130 comes into contact with the external environment 500 at the contact point P1, the mobile body 100 has an elastic modulus lower than that of the first elastic member 131A and the contact area with the external environment 500 is large, so that it is possible to suppress generation of a landing sound with respect to the external environment. Furthermore, since the mobile body 100 has the large contact area with the external environment 500, a frictional force with the external environment 500 can be improved as compared with the contact point P2.

In a state ST2, the mobile body 100 is in contact with the external environment 500 at the contact point P2 of the contact portion 130. The contact point P2 is a portion where a curvature radius of the first elastic member 131A is large, that is, a portion where a contact area of the first elastic member 131A is small. For example, when the contact portion 130 comes into contact with the external environment 500 at the contact point P2, the mobile body 100 has an elastic modulus higher than that of the second elastic member 131B and the contact area with the external environment 500 is small, so that stress from the external environment 500 at the time of landing can be improved.

In a state ST3, the mobile body 100 is in contact with the external environment 500 at the contact point P3 of the contact portion 130. The contact point P3 is a portion where the curvature radius of the first elastic member 131A is small, that is, a portion where the contact area of the first elastic member 131A is large. For example, when the contact portion 130 comes into contact with the external environment 500 at the contact point P3, the mobile body 100 has an elastic modulus higher than that of the second elastic member 131B and the contact area with the external environment 500 is large, so that a frictional force with the external environment 500 can be improved as compared with the contact point P2.

In a state ST4, the mobile body 100 is in contact with the external environment 500 at the contact point P4 of the contact portion 130. The contact point P4 is a portion where the radius of curvature of the second elastic member 131B is large, that is, a portion where the contact area of the second elastic member 131B is small. For example, when the contact portion 130 comes into contact with the external environment 500 at the contact point P4, the mobile body 100 has an elastic modulus lower than that of the first elastic member 131A and the contact area with the external environment 500 is small, so that stress from the external environment 500 at the time of landing can be absorbed more than the contact points P2 and P3.

For example, in a conventional legged mobile robot, an operation sound of the legged mobile robot is identified, and a stride is reduced or a center of gravity is lowered to alleviate an impact at the time of landing based on a result of the identification. However, in the conventional technique, even if the operation sound can be suppressed, the landing sound may be recognized as a noise by surrounding people. In the following description, an example in which the mobile body 100 of the legged movement realizes changing of the landing sound of the leg portions 120 according to the external environment will be described.

[Configuration of Mobile Body According to First Embodiment]

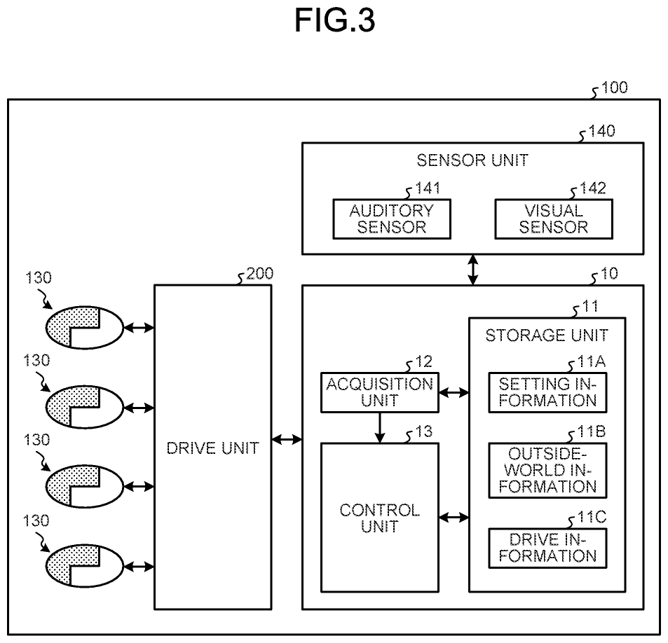

FIG. 3 is a diagram illustrating an example of a configuration of the mobile body according to the first embodiment. As illustrated in FIG. 3, the mobile body 100 further includes a plurality of contact portions 130, a sensor unit 140, a drive unit 200, and a control device 10.

The drive unit 200 drives each drivable portion of the mobile body 100. The drive unit 200 includes an actuator that drives the first joint 121 and the second joint 122 of the leg portion 120. The drive unit 200 is electrically connected to the control device 10 and is controlled by the control device 10. Furthermore, the drive unit 200 rotates the contact portions 130 by driving a motor or the like. The mobile body 100 according to the first embodiment is configured to be capable of walking movement by the leg portions 120.

As described above, each of the plurality of contact portions 130 is provided in each of the plurality of leg portions 120. The contact portions 130 are provided at portions where the leg portions 120 each come into contact with the external environment 500. The contact portions 130 are electrically connected to the drive unit 200 and are driven by the drive unit 200.

The sensor unit 140 is provided in the mobile body 100 and detects outside-world information around the mobile body 100. The outside-world information includes information indicating a surrounding sound, an image, a distance, a position, and the like. The sensor unit 140 is configured to be able to supply the detected outside-world information to the control device 10. In the present embodiment, the sensor unit 140 includes, for example, an auditory sensor 141 and a visual sensor 142. The sensor unit 140 may include other sensors that detect information used for processing of the mobile body 100.

The auditory sensor 141 detects, for example, outside-world information including an environmental sound, a contact sound, and the like. The auditory sensor 141 includes, for example, a microphone, a video camera, and the like. The auditory sensor 141 is provided in the main body 110 or the like so as to be able to collect, for example, an environmental sound, a contact sound, and the like around the mobile body 100. The auditory sensor 141 is provided, for example, in the vicinity of the contact portion 130 of the leg portion 120 so as to be able to collect the landing sound of the leg portion 120 of the mobile body 100.

The visual sensor 142 detects outside-world information including imaging information obtained by imaging an external environment in which the mobile body 100 moves. The visual sensor 142 includes, for example, a time of flight (ToF) camera, a stereo camera, a monocular camera, an infrared camera, and the like. The visual sensor 142 is provided, for example, in the main body 110 or the like so as to be able to image an external environment around the mobile body 100, a road surface condition in a moving direction, and the like.

The sensor unit 140 may have a configuration for acquiring position information indicating a position of the mobile body 100. For example, the sensor unit 140 may include a global positioning system (GPS), a communication device, simultaneous localization and mapping (SLAM), and the like. The sensor unit 140 may have a configuration for acquiring information that can specify a movement result of the mobile body 100. For example, the sensor unit 140 may include an encoder that detects the rotation of the actuator, a speed sensor, an acceleration sensor, and the like.

The control device 10 is, for example, a device that controls an operation of the mobile body 100. The control device 10 is, for example, a dedicated or general-purpose computer. The control device 10 includes a storage unit 11, an acquisition unit 12, and a control unit 13. The control device 10 is provided, for example, in the main body 110 of the mobile body 100. In the present embodiment, each processing unit of the acquisition unit 12 and the control unit 13 is realized by, for example, a central processing unit (CPU), a micro control unit (MCU), or the like to execute a program stored inside the control device 10 with a random access memory (RAM) or the like as a work area. Furthermore, each processing unit may be realized by, for example, an integrated circuit such as an application specific integrated circuit (ASIC) or a field-programmable gate array (FPGA).

The storage unit 11 stores various data and programs. The storage unit 11 is realized by, for example, a semiconductor memory element such as a RAM or a flash memory, or a storage device such as a hard disk or an optical disk. Note that the storage unit 11 may be provided outside the mobile body 100. Specifically, the storage unit 11 may be provided in a cloud server connected to the control device 10 via a network.

The storage unit 11 stores, for example, information such as setting information 11A, outside-world information 11B, and drive information 11C. The setting information 11A includes, for example, information indicating various settings, movement plans, and the like of the mobile body 100. The setting information 11A includes information indicating a relationship between the contact points P1, P2, P3, and P4 of the contact portions 130 and the characteristics of the contact portions 130. The outside-world information 11B is, for example, outside- world information supplied by the sensor unit 140. The drive information 11C includes information indicating a landing timing, a control parameter, and the like of the leg portions 120. The drive information 11C includes, for example, information indicating a control parameter for rearranging the contact points P1, P2, P3, and P4 of the contact portions 130.

The acquisition unit 12 acquires the outside-world information 11B around the mobile body from the sensor unit 140. The acquisition unit 12 is an interface for acquiring the outside-world information from the sensor unit 140. The acquisition unit 12 stores the acquired outside-world information 11B in the storage unit 11 and supplies the acquired outside-world information to the control unit 13. The acquisition unit 12 acquires the outside-world information 11B including an environmental sound around the mobile body 100. The acquisition unit 12 acquires the outside-world information 11B including image information obtained by imaging the environment in which the mobile body 100 moves. The acquisition unit 12 may have a function for extracting an environmental sound, a landing sound, a human speech, and the like from the acquired outside- world information 11B. For example, the acquisition unit 12 may perform automatic speech recognition (ASR) processing and natural language understanding (NLU) processing to understand utterance data.

The control unit 13 controls the drive unit 200. The control unit 13 drives each drivable portion of the mobile body 100. For example, the control unit 13 realizes processing related to various operations of the mobile body 100 by executing a program. For example, the control unit 13 controls walking by the plurality of leg portions 120 so as to move the mobile body 100 on the basis of a movement plan. The control unit 13 controls the operations of the plurality of leg portions 120 so as to achieve a desired gait. For example, in a case where the mobile body 100 walks with the four leg portions 120, the gait includes static walk, walking trot, running trot, bound, and the like.

The control unit 13 performs control to switch the characteristics of the contact portion 130 capable of switching the characteristics of the portion where the leg portion 120 of the mobile body 100 comes into contact with the external environment 500 on the basis of the outside-world information 11B such that the contact sound between the contact portion 130 and the external environment 150 changes. The characteristics of the contact portion 130 are, for example, characteristics of a toe where the leg portion 120 comes into contact with the external environment 500. The characteristics of the contact portion 130 include, for example, at least one of physical characteristics such as an elastic modulus, a Poisson's ratio, a friction coefficient, and a contact area.

The control unit 13 has a function for performing control to switch the characteristics of the contact portion 130 on the basis of an environmental sound when the acquisition unit 12 acquires the outside-world information 11B including the environmental sound. The control unit 13 has a function for performing control to switch the characteristics of the contact portion 130 on the basis of the environmental sound acquired at a second timing different from a first timing at which the leg portion 120 and the external environment 500 come into contact with each other.

The control unit 13 has a function for classifying types of an environmental sound and performing control to switch the characteristics of the contact portion 130 on the basis of the classified types of the environmental sound. The types of the environmental sounds include, for example, a type of a sound in which humans are having a conversation around the mobile body 100, a type of a sound in which a human is speaking to the mobile body 100, a type of a sound not including a voice, and the like. In a case where the environmental sound includes a voice of a human, the control unit 13 has a function for performing, by using a voice recognition function, control to switch the characteristics of the contact portion 130 so that the contact sound becomes smaller when the voice includes a voice that requires silence.

The configuration examples of the mobile body 100 and the control device 10 according to the first embodiment have been described above. Note that the above-described configuration described with reference to FIGS. 1 to 3 is merely an example, and the configurations of the mobile body 100 and the control device 10 according to the present embodiment are not limited to such an example. The functional configurations of the mobile body 100 and the control device 10 according to the present embodiment can be flexibly modified according to specifications and operations.

[Processing Procedure of Control Device According to First Embodiment]

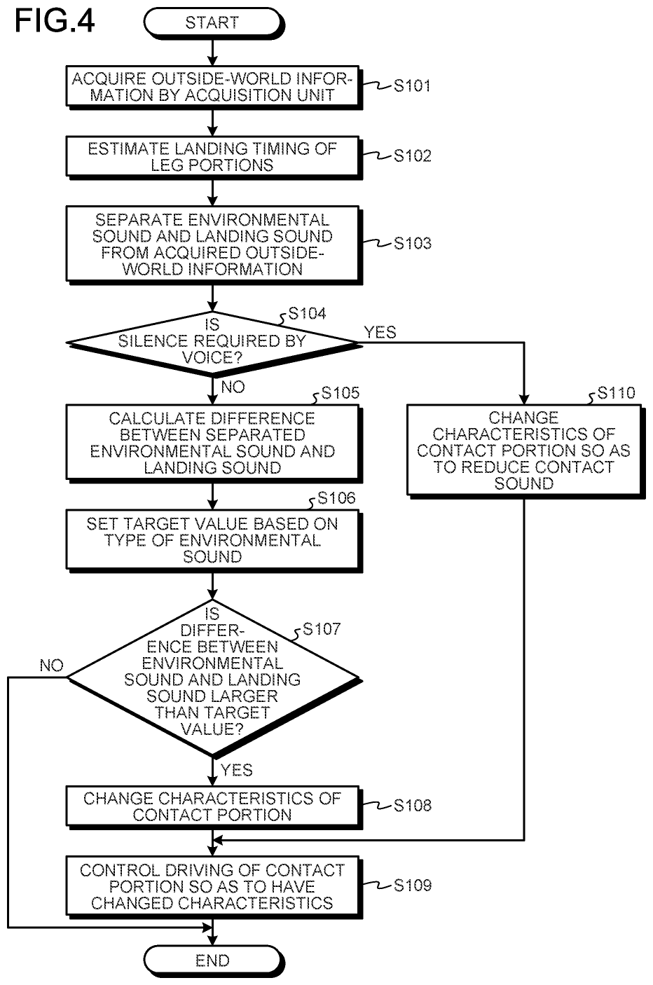

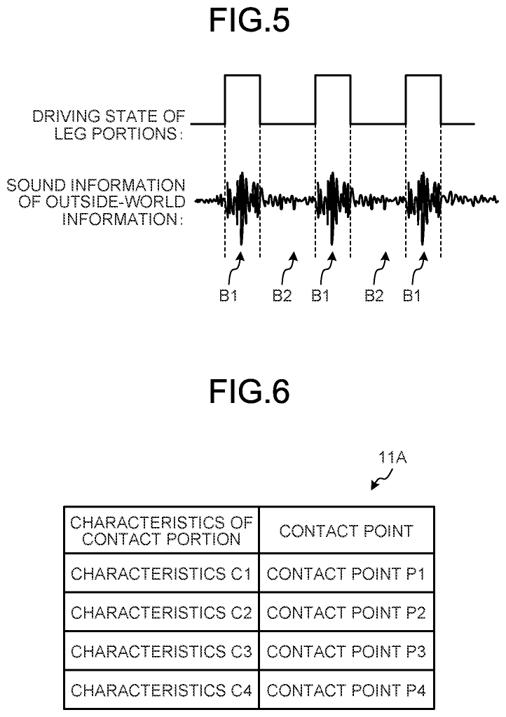

Next, an example of a processing procedure of the control device 10 according to the first embodiment will be described. FIG. 4 is a flowchart illustrating an example of a processing procedure executed by the control device 10 according to the first embodiment. FIG. 5 is a diagram for explaining a relationship between an environmental sound and a landing sound according to the first embodiment. FIG. 6 is a diagram for explaining a relationship between the characteristics of the contact portion 130 and the contact point according to the first embodiment. The processing procedure illustrated in FIG. 4 is realized by the control unit 13 of the control device 10 executing a program. The processing procedure illustrated in FIG. 4 is repeatedly executed by the control unit 13 in a state where the leg portions 120 are driven.

As illustrated in FIG. 4, the control unit 13 of the control device 10 acquires the outside-world information 11B by the acquisition unit 12 (Step S101). For example, the control unit 13 causes the acquisition unit 12 to acquire the outside-world information 11B detected by the sensor unit 140, whereby the outside-world information 11B is stored in the storage unit 11 in time series. The control unit 13 estimates a landing timing of the leg portions 120 of the mobile body 100 (Step S102). For example, the control unit 13 estimates the landing timing of the four leg portions 120 being driven on the basis of the drive information 11C, and stores a result of the estimation in the storage unit 11. Upon completion of the processing in Step S102, the control unit 13 advances the processing to Step S103.

The control unit 13 separates the environmental sound and the landing sound from the acquired outside-world information 11B (Step S103). For example, the control unit 13 separates the environmental sound and the landing sound on the basis of the landing timing of the leg portions 120 estimated in

Step S102, and stores a result of the separation in the storage unit 11. In the example illustrated in FIG. 5, the control unit 13 compares the driving state of the leg portions 120 with the sound information of the outside-world information 11B. The control unit 13 recognizes that a section B1 of the outside-world information 11B is a section of the landing timing of the leg portions 120 in a predetermined detection target range. The control unit 13 recognizes that a section B2 of the outside- world information 11B is a section that is not the landing timing of the leg portions 120 in the predetermined detection target range. That is, the section B2 of the outside-world information 11B is a section that does not include the landing sound and includes only the environmental sound. The control unit 13 separates the landing sound indicating the sound in the section B1 of the outside-world information 11B and the environmental sound indicating the sound in the section B2. For example, the control unit 13 may classify types of the separated environmental sound, and store in the storage unit 11 a result of the classification in association with the classified result. Returning to FIG. 4, when the control unit 13 stores the information indicating the result of the separation in the storage unit 11, the processing proceeds to Step S104.

The control unit 13 determines whether or not silence is required by voice (Step S104). For example, when a human voice is included in the environmental sound and a voice requiring silence is included in the environmental sound as a result of the voice recognition processing, the control unit 13 determines that silence is required by the voice. In a case where the control unit 13 determines that silence is not required by the voice (No in Step S104), the processing proceeds to Step S105.

The control unit 13 calculates a difference between the separated environmental sound and landing sound (Step S105). For example, the control unit 13 calculates the difference between the maximum value of the environmental sound and the maximum value of the landing sound, and stores a result of the calculation in the storage unit 11. The control unit 13 sets a target value based on the type of the environmental sound (Step S106). For example, the setting information 11A includes information for associating the type of the environmental sound with the target value. In this case, the control unit 13 estimates the type of the environmental sound, acquires a target value corresponding to the estimated type from the setting information 11A, and sets the target value as a target value. Upon completion of the processing in Step S105, the control unit 13 advances the processing to Step S107.

The control unit 13 determines whether or not the difference between the environmental sound and the landing sound is larger than the target value (Step S107). When it is determined that the difference between the environmental sound and the landing sound is not larger than the target value (No in Step S107), the control unit 13 ends the processing procedure illustrated in FIG. 4. In addition, in a case where the control unit 13 determines that the difference between the environmental sound and the landing sound is larger than the target value (Yes in Step S107), the processing proceeds to Step S108.

The control unit 13 changes the characteristics of the contact portion 130 (Step S108). For example, since the difference between the environmental sound and the landing sound is larger than the target value, the control unit 13 changes the characteristics of the contact portion 130 so that the landing sound becomes inconspicuous. For example, the control unit 13 changes the characteristics of the contact portion 130 that cancels the difference between the environmental sound and the landing sound on the basis of the setting information 11A. For example, the control unit 13 changes the characteristics of the contact portion 130 on the basis of the environmental sound and the imaging information such that the landing sound becomes inconspicuous and a frictional force with the external environment 500 changes. Upon completion of the processing in Step S108, the control unit 13 advances the processing to Step S109.

The control unit 13 controls driving of the contact portion 130 so as to have the changed characteristics (Step S109). For example, the control unit 13 specifies the contact point corresponding to the characteristics of the contact portion 130 on the basis of the setting information 11A so as to have the changed characteristics. In the example illustrated in FIG. 6, the setting information 11A indicates a relationship between the characteristics of the contact portion 130 and the contact point. The setting information 11A indicates the contact point P1 in the case of the characteristics C1, the contact point P2 in the case of the characteristics C2, the contact point P3 in the case of the characteristics C3, and the contact point P4 in the case of the characteristics C4. The setting information 11A indicates, for example, a relationship between the characteristics of the contact portion 130 and the contact point, which enables both noise reduction of the contact portion 130 and motion performance by using machine learning. For example, the setting information 11A indicates a relationship between characteristics according to a road surface condition or the like around the mobile body 100 and the contact point. The control unit 13 performs control to cause the drive unit 200 to rotate the contact portion 130 so that the specified contact point comes into contact with the external environment 500 on the basis of the setting information 11A. As a result, the contact portion 130 comes into contact with the external environment 500 at the contact point having the characteristics changed by the control unit 13. Returning to FIG. 4, when the processing of Step S109 is ended, the control unit 13 ends the processing procedure illustrated in FIG. 4.

Furthermore, in a case where the control unit 13 determines that silence is required by voice (Yes in Step S104), the processing proceeds to Step S110. The control unit 13 changes the characteristics of the contact portion 130 so as to reduce the contact sound (Step S110). For example, the control unit 13 makes a change to the characteristics of the contact portion 130 so as to be silent in the external environment 500. Upon completion of the processing in Step S110, the control unit 13 advances the processing to Step S109 already described.

The control unit 13 controls driving of the contact portion 130 so as to have the changed characteristics (Step S109). For example, the control unit 13 performs control to cause the drive unit 200 to rotate the contact portion 130 so that the specified contact point comes into contact with the external environment 500. As a result, the contact portion 130 comes into contact with the external environment 500 at the contact point at which the contact sound decreases, which has been changed by the control unit 13. When the processing of Step S109 ends, the control unit 13 ends the processing procedure illustrated in FIG. 4.

[Operation of Mobile Body According to First Embodiment]

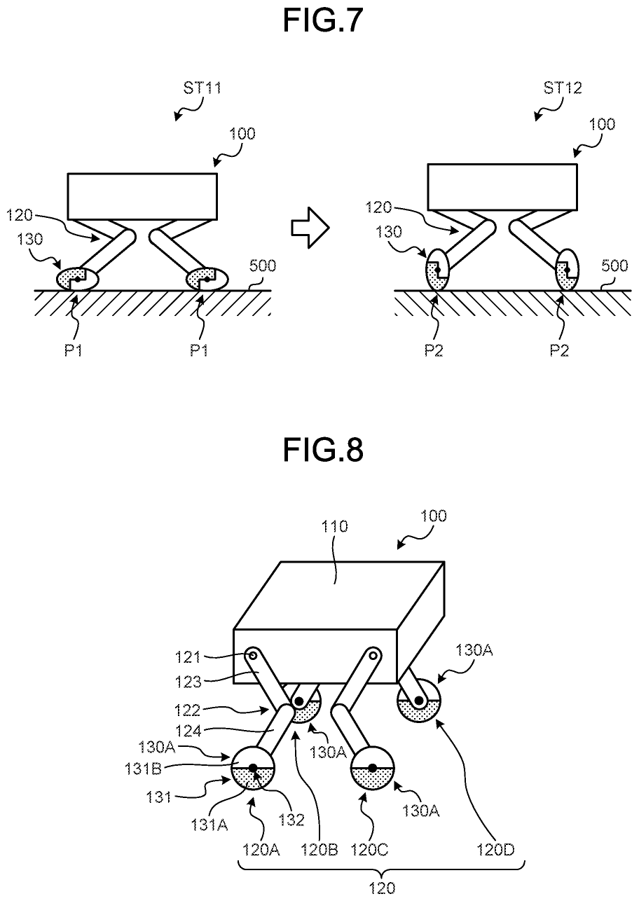

Next, an example of the operation of the mobile body 100 will be described with reference to FIG. 7. FIG. 7 is a diagram illustrating an example of an operation related to the contact portion 130 of the mobile body 100 according to the first embodiment.

In a state ST11 illustrated in FIG. 7, the mobile body 100 is walking and moving by driving the leg portions 120. The surrounding environment of the mobile body 100 is, for example, an environment in which a human is present and it is preferable to reduce the landing sound of the leg portions 120. Therefore, the control device 10 of the mobile body 100 rotates the contact portion 130 by the drive unit 200 to bring the contact portion 130 into contact with the external environment 500 at the contact point P1. The contact point P1 is a portion where an elastic modulus is lower than that of the first elastic member 131A and a contact area of the second elastic member 131B is large. As a result, in a case where the mobile body 100 walks with the leg portions 120, the contact portions 130 of the leg portions 120 land (come into contact with) the external environment 500 at the contact points P1, so that the generated landing sound can be reduced. As a result, in a case where a human is present in the surroundings, the mobile body 100 can suppress generation of a noise due to the landing sound.

In a state ST12, the mobile body 100 continues walking movement by driving the leg portions 120. For example, the surrounding environment of the mobile body 100 has changed from the state ST11 to an environment in which there is no human around, and the landing sound of the leg portions 120 may be large. Therefore, the control device 10 of the mobile body 100 rotates the contact portion 130 by the drive unit 200 to bring the contact portion 130 into contact with the external environment 500 at the contact point P2. The contact point P2 is a portion where a contact area of the first elastic member 131A having an elastic modulus higher than that of the second elastic member 131B is small. As a result, in a case where the mobile body 100 walks with the leg portions 120, the contact portions 130 of the leg portions 120 land (come into contact with) the external environment 500 at the contact points P2, and thus the generated landing sound becomes larger than that in the state ST11. However, since the elastic forces of the contact portions 130 are high, the movement of the leg portions 120 becomes smooth. As a result, in a case where there is no human in the surroundings, the mobile body 100 can suppress a load related to the movement of the mobile body 100.

As described above, the control device 10 according to the first embodiment switches the characteristics of the contact portion 130 on the basis of the outside-world information 11B around the mobile body 100 so that the contact sound between the contact portion 130 of the leg portion 120 and the external environment 500 changes. As a result, the control device 10 can change the contact sound between the leg portion 120 and the external environment 500 by switching the characteristics of the contact portion 130 of the leg portion 120 according to the surrounding situation and the like. As a result, the control device 10 can change the landing sound of the leg portion 120 of the mobile body 100 according to the external environment. In addition, the control device 10 can contribute to coexistence of the mobile body 100 and a human by changing the contact sound of the mobile body 100.

Furthermore, the control device 10 acquires the outside-world information 11B including the environmental sound around the mobile body 100, and switches the characteristics of the contact portion 130 of the leg portion 120 on the basis of the environmental sound. As a result, the control device 10 can improve the accuracy of recognizing the surrounding environment with respect to the environmental sound, and thus, can highly accurately suppress the generation of a noise due to the landing sound of the leg portion 120 of the mobile body 100.

Furthermore, the control device 10 can acquire the outside-world information 11B including imaging information around the mobile body 100, and switch the characteristics of the contact portion 130 on the basis of imaging information of the external environment 500 included in the imaging information. As a result, the control device 10 can improve the motion performance of the mobile body 100 by changing the characteristics of the contact portion 130 to be suitable for a road surface condition and the like around the mobile body 100.

[First Modification of First Embodiment (1)]

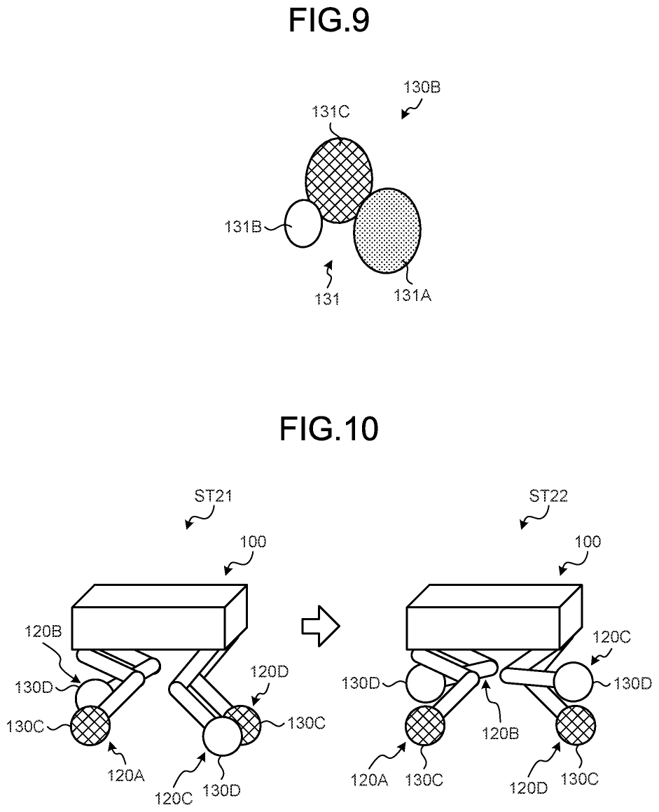

Next, a first modification of the first embodiment will be described. In the first embodiment, the case where the contact portion 130 of the leg portion 120 of the mobile body 100 is formed in an elliptical columnar shape has been described, but the present invention is not limited thereto. In the first modification of the first embodiment, an example of another shape of the contact portion 130 to be controlled by the control device 10 will be described. FIG. 8 is a perspective view for explaining an example of a mobile body 100 according to the first modification of the first embodiment. FIG. 9 is a diagram for explaining another example of a contact portion of the mobile body 100 according to the first modification of the first embodiment.

As illustrated in FIG. 8, the mobile body 100 includes a main body 110 and four leg portions 120. The leg portion 120 includes a first joint 121, a second joint 122, a first link 123, a second link 124, and a contact portion 130A. The contact portion 130A includes a cylindrical elastic member 131 and a holding mechanism 132 that rotatably holds the elastic member 131.

The contact portion 130A is provided at a distal end of the leg portion 120 so as to be able to contact the external environment 500. The contact portion 130A is provided at the distal end of the second link 124 of the leg portion 120. The contact portion 130A includes a cylindrical elastic member 131 and a holding mechanism 132 that rotatably holds the elastic member 131. The elastic member 131 has a circular cross section in a longitudinal direction of the main body 110. The elastic member 131 includes a first elastic member 131A and a second elastic member 131B. The first elastic member 131A and the second elastic member 131B are formed in a semi-cylindrical shape. The first elastic member 131A and the second elastic member 131B are integrated to form the cylindrical elastic member 131. The first elastic member 131A is formed of a member having an elastic modulus higher than that of the second elastic member 131B.

The holding mechanism 132 is controlled by the main body 110 so that the elastic member 131 can be brought into contact with the external environment at one of two contact points. The two contact points include a first point at which the external environment and the first elastic member 131A are in contact, and a second point at which the external environment and the second elastic member 131B are in contact. In addition, the contact portion 130A may have three contact points by including a third point at which the external environment and a connection portion of the first elastic member 131A and the second elastic member 131B are in contact with each other as a contact point.

The mobile body 100 is configured to come into contact with the external environment 500 at one of the two contact points of the contact portion 130A under the control of the control device 10. That is, the control device 10 of the mobile body 100 switches the two contact points of the contact portion 130A to make contact with the external environment 500. As a result, the control device 10 can change the contact sound between the leg portion 120 and the external environment 500 by changing the characteristics of the contact portion 130A on the basis of the outside-world information 11B. As a result, the control device 10 can change the landing sound of the leg portion 120 of the mobile body 100 according to the external environment.

In addition, in the mobile body 100, the contact portion 130A of the leg portion 120 can be replaced with a contact portion 130B illustrated in FIG. 9. The contact portion 130B includes an elastic member 131 and a holding mechanism 132 (not illustrated). The elastic member 131 includes a first elastic member 131A, a second elastic member 131B, and a third elastic member 131C. The first elastic member 131A is a member having an elastic modulus higher than those of the second elastic member 131B and the third elastic member 131C, and is formed in a columnar shape. The second elastic member 131B is a member having an elastic modulus higher than that of the third elastic member 131C, and is formed in a columnar shape smaller than the first elastic member 131A. The third elastic member 131C is a member having an elastic modulus lower than those of the first elastic member 131A and the second elastic member 131B, and is formed in a columnar shape smaller than the second elastic member 131B.

The holding mechanism 132 is configured to selectively position one of the first elastic member 131A, the second elastic member 131B, and the third elastic member 131C at the contact portion of the leg portion 120. The control device 10 drives the holding mechanism 132 by the drive unit 200 to switch the first elastic member 131A, the second elastic member 131B, and the third elastic member 131C, thereby changing the characteristics of the contact portion 130B. As a result, the control device 10 can change the contact sound between the leg portion 120 and the external environment 500 by changing the characteristics of the contact portion 130B on the basis of the outside-world information 11B. As a result, the control device 10 can change the landing sound of the leg portion 120 of the mobile body 100 according to the external environment 500.

[Second Modification of First Embodiment (2)]

Next, a second modification of the first embodiment will be described. In the first embodiment, the case where the same contact portions 130 are provided in the four leg portions 120 of the mobile body 100 has been described, but the present invention is not limited thereto. In the second modification of the first embodiment, an example in which different contact portions are provided in the four leg portions 120 of the mobile body 100 will be described. FIG. 10 is a diagram for explaining an example of a mobile body 100 according to the second modification of the first embodiment.

As illustrated in FIG. 10, the mobile body 100 includes a main body 110 and a plurality of leg portions 120. Each of the plurality of leg portions 120 has a contact portion 130C or a contact portion 130D. The contact portion 130C is an elastic member having an elastic modulus lower than that of the contact portion 130D, and is formed in a columnar shape. The contact portion 130D is an elastic member having an elastic modulus higher than that of the contact portion 130C, and is formed in a columnar shape. That is, in the mobile body 100, the plurality of leg portions 120 are provided with either the contact portion 130C or the contact portion 130D having different characteristics.

In the example illustrated in FIG. 10, the mobile body 100 includes four leg portions 120A, 120B, 120C, and 120D. In the mobile body 100, the contact portions 130C are provided in the leg portion 120A and the leg portion 120D, and the contact portions 130D are provided in the leg portion 120B and the leg portion 120C. In this case, the control device 10 performs walking control by changing the number of the leg portions 120 used for walking.

For example, in a state ST21, the surrounding environment of the mobile body 100 is an environment in which no human is present around the mobile body 100. In this case, since there is no problem even if the landing sound of the leg portions 120 occurs, the control device 10 drives all of the four leg portions 120 to move the mobile body 100. As a result, when the mobile body 100 moves, the control device 10 generates a landing sound when the contact portions 130D come into contact with the external environment 500.

In addition, in a state ST22, the surrounding environment of the mobile body 100 is an environment in which a human is present around the mobile body 100 and it is preferable to reduce the landing sound of the leg portions 120. In this case, the control device 10 drives the two leg portions 120A and 120D provided with the contact portions 130C having a low elastic modulus to move the mobile body 100. As a result, even if the mobile body 100 moves, the control device 10 causes only the contact portions 130C having a low elastic modulus to land on (contact) the external environment 500, so that the landing sound of the leg portions 120 can be suppressed.

In the second modification of the first embodiment, the case where the control device 10 changes the characteristics of the toes of the leg portions 120 by performing the control to change the number of the leg portions 120 used for walking of the mobile body 100 has been described, but the present invention is not limited thereto. For example, the control device 10 may change the characteristics of the toes of the leg portions 120 by changing the number of the leg portions 120 to be driven to two, three, or four.

[Third Modification of First Embodiment (3)]

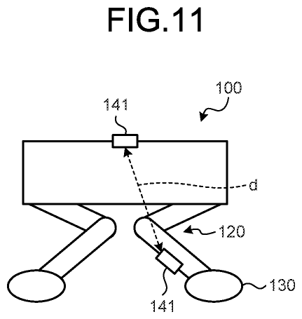

Next, a third modification of the first embodiment will be described. FIG. 11 is a diagram for explaining an example of a control device 10 according to the third modification of the first embodiment. As illustrated in FIG. 11, in a mobile body 100 according to the third modification of the first embodiment, auditory sensors 141 are provided in the vicinity of a contact portion 130 of a leg portion 120 and on an upper surface of a main body 110. In this case, the control device 10 separates sound information of the outside-world information 11B on the basis of a difference in a distance d between the auditory sensors 141 of the main body 110 and the leg portion 120. For example, the control device 10 grasps in advance the distance d between the auditory sensor 141 of the main body 110 and the auditory sensor 141 of the leg portion 120 according to a posture of the mobile body 100. The control device 10 can separate and grasp the landing sound of the mobile body 100 and the environmental sound by calculating the sounds detected by the respective auditory sensors 141 in consideration of the difference in the distance d.

Note that the first to third modifications of the first embodiment may be applied to the mobile body 100 and the control device 10 of other embodiments and modifications.

### Second Embodiment

[Configuration Example of Mobile Body According to Second Embodiment]

Next, the second embodiment will be described. A mobile body 100 according to the second embodiment has the same configuration as that of the first embodiment illustrated in FIGS. 1 to 3. The mobile body 100 includes a main body 110, four leg portions 120, a plurality of contact portions 130, a sensor unit 140, a drive unit 200, and a control device 10. The control device 10 includes a storage unit 11, an acquisition unit 12, and a control unit 13.

The control unit 13 illustrated in FIG. 3 performs control to change at least one of an operation and a gait when the leg portions 120 come into contact with the external environment 500 on the basis of the outside-world information 11B. The control unit 13 performs control to change the speed and the acceleration when the leg portions 120 come into contact with the external environment 500 on the basis of the outside-world information 11B. The control unit 13 performs control to change the gait of the leg portions 120 on the basis of the outside-world information 11B so that the contact sound between the contact portions 130 and the external environment 500 changes. For example, the control unit 13 changes the characteristics of the contact portions 130 and changes the gait of the leg portions 120. For example, in a case where it is necessary to reduce the landing sound, the control unit 13 changes the contact points of the contact portions 130 and changes the driving of the leg portions 120 so as to reduce the speed and acceleration related to landing of the contact portions 130. As a result, the control unit 13 can lower the landing sound of the leg portions 120 as compared with the case of only changing the characteristics of the contact portions 130.

The configuration example of the control device 10 according to the second embodiment has been described above. Note that the above-described configuration described with reference to FIG. 3 is merely an example, and the configuration of the control device 10 according to the second embodiment is not limited to such an example. The functional configuration of the control device 10 according to the second embodiment can be flexibly modified according to specifications and operations.

[Processing Procedure of Control Device According to Second Embodiment]

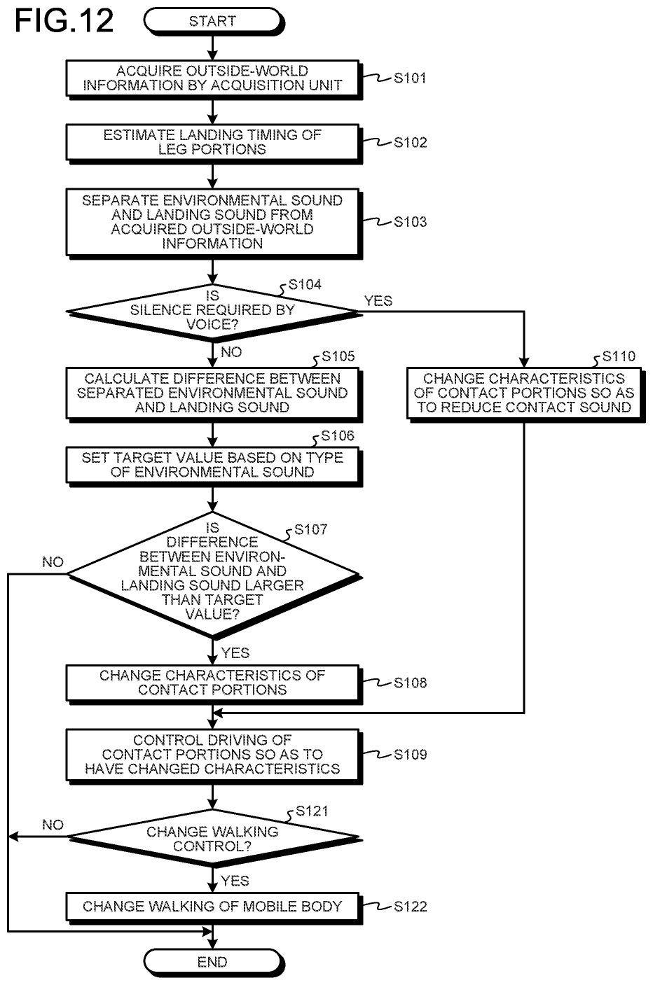

Next, an example of a processing procedure of the control device 10 according to the second embodiment will be described with reference to FIG. 12. FIG. 12 is a flowchart illustrating an example of a processing procedure executed by the control device 10 according to the second embodiment. The processing procedure illustrated in FIG. 12 is realized by the control unit 13 of the control device 10 executing a program. The processing procedure illustrated in FIG. 12 is repeatedly executed by the control unit 13 in a state where the leg portions 120 are driven. In the processing procedure illustrated in FIG. 12, the processing from Step S101 to Step S110 is the same as the processing from Step S101 to Step S110 illustrated in FIG. 4.

As illustrated in FIG. 12, the control unit 13 of the control device 10 acquires the outside-world information 11B by the acquisition unit 12 (Step S101). The control unit 13 estimates a landing timing of the leg portions 120 of the mobile body 100 (Step S102). The control unit 13 separates the environmental sound and the landing sound from the acquired outside-world information 11B (Step S103). The control unit 13 determines whether or not silence is required by voice (Step S104). In a case where the control unit 13 determines that silence is not required by the voice (No in Step S104), the processing proceeds to Step S105.

The control unit 13 calculates a difference between the separated environmental sound and landing sound (Step S105). The control unit 13 sets a target value based on the type of the environmental sound (Step S106). The control unit 13 determines whether or not the difference between the environmental sound and the landing sound is larger than the target value (Step S107). When it is determined that the difference between the environmental sound and the landing sound is not larger than the target value (No in Step S107), the control unit 13 ends the processing procedure illustrated in FIG. 4. In addition, in a case where the control unit 13 determines that the difference between the environmental sound and the landing sound is larger than the target value (Yes in Step S107), the processing proceeds to Step S108.

The control unit 13 changes the characteristics of the contact portion 130 (Step S108). The control unit 13 controls driving of the contact portion 130 so as to have the changed characteristics (Step S109). Upon completion of the processing in Step S109, the control unit 13 advances the processing to Step S121 described later.

Furthermore, in a case where the control unit 13 determines that silence is required by voice (Yes in Step S104), the processing proceeds to Step S110. The control unit 13 changes the characteristics of the contact portion 130 so as to reduce the contact sound (Step S110). Upon completion of the processing in Step S110, the control unit 13 controls driving of the contact portions 130 so as to have the changed characteristics (Step S109). Upon completion of the processing in Step S109, the control unit 13 advances the processing to Step S121.

The control unit 13 determines whether or not to change the walking control (Step S121). For example, the control unit 13 determines to change the walking control in a case where the environmental sound is small, a human is present, and noise reduction is required on the basis of the outside-world information 11B. For example, when silence is requested from a human, the control unit 13 determines to change walking control. For example, the control unit 13 determines to change the walking control in a case where a road surface condition such as presence of unevenness in the external environment 500 or wetting of the external environment 500 is specified on the basis of the outside-world information 11B. When determining not to change the walking control (No in Step S121), the control unit 13 ends the processing procedure illustrated in FIG. 12. Furthermore, in a case where the control unit 13 determines to change the walking control (Yes in Step S121), the processing proceeds to Step S122.

The control unit 13 changes the walking of the mobile body 100 (Step S122). For example, the control unit 13 changes a parameter or the like for controlling the driving of the leg portions 120 according to the situation of the external environment 500. The parameter includes, for example, information such as torque, speed, and acceleration of the joints of the leg portions 120. The control unit 13 controls the operation of the drive unit 200 by outputting an operation command according to the changed parameter to the drive unit 200. For example, the control unit 13 may change a parameter or the like for controlling the driving of the leg portions 120 so as to obtain a gait suitable for the situation of the external environment 500. As a result, the mobile body 100 walks and moves with the changed gait of the leg portions 120. Upon completion of the processing in Step S122, the control unit 13 ends the processing procedure illustrated in FIG. 12.

[Operation of Mobile Body According to Second Embodiment]

Next, an example of the operation of the mobile body 100 according to the second embodiment will be described. For example, it is assumed that the surrounding environment of the mobile body 100 is, for example, an environment in which a human is present and it is preferable to reduce the landing sound of the leg portions 120. In this case, the control device 10 of the mobile body 100 rotates the contact portions 130 by the drive unit 200 to bring the contact portions 130 into contact with the external environment 500 at the contact points P1. Furthermore, the control device 10 changes the walking of the leg portions 120 of the mobile body 100 so that the contact portions 130 of the leg portions 120 come into contact with the external environment 500 at a low speed. As a result, in a case where the mobile body 100 walks with the leg portions 120, the contact portions 130 of the leg portions 120 land (come into contact with) the external environment 500 at the contact points P1 at a low speed, so that the generated landing sound can be further reduced. As a result, in a case where a human is present in the surroundings, the mobile body 100 can suppress generation of a noise due to the landing sound.

Note that the second embodiment may be applied to the control device 10 and the like of other embodiments and modifications.

[Hardware Configuration]

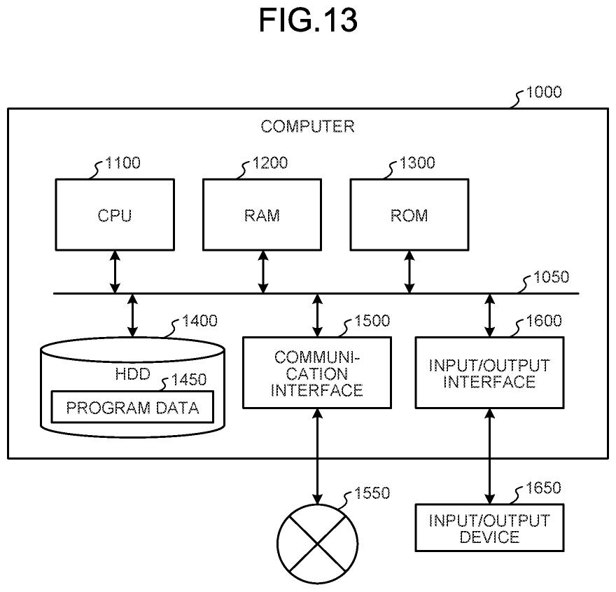

The control device 10 according to the first to second embodiments described above may be realized by, for example, a computer 1000 having a configuration as illustrated in FIG. 13. Hereinafter, the control device 10 according to the embodiments will be described as an example. FIG. 13 is a hardware configuration diagram illustrating an example of the computer 1000 that implements the functions of the control device 10. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program in the RAM 1200, which is stored in the ROM 1300 or the HDD 1400, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data to be used by such a program, and the like. Specifically, the HDD 1400 is a recording medium that records an information processing program according to the present disclosure, which is an example of program data 1450.

The communication interface 1500 is an interface for the computer 1000 to connect to an external network 1550 (for example, the Internet). For example, the CPU 1100 receives data from other device or transmits data generated by the CPU 1100 to other device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the control device 10 according to the embodiments, the CPU 1100 of the computer 1000 implements the functions of the control unit 13 and the like by executing a program loaded on the RAM 1200. In addition, the HDD 1400 stores a program according to the present disclosure and data in the storage unit 11. Note that the CPU 1100 reads the program data 1450 from the HDD 1400 and executes the program data, but as another example, these programs may be acquired from other devices via the external network 1550.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

In addition, it is also possible to create a program for causing hardware such as a CPU, a ROM, and a RAM built in a computer to exhibit a function equivalent to the configuration of the control device 10, and a computer-readable recording medium recording the program can also be provided.

Furthermore, each Step related to the processing of the control device 10 of the present specification is not necessarily processed in time series in the order described in the flowcharts. For example, each Step related to the processing of the control device 10 may be processed in an order different from the order described in the flowcharts, or may be processed in parallel.

In the first and second embodiments, the case where the control device 10 is provided in the mobile body 100 has been described, but the present invention is not limited thereto. For example, the control device 10 may be provided outside the mobile body 100. In this case, the control device 10 may transmit and receive various types of information to and from the mobile body 100 by communication via a communication device, for example, and may acquire information such as the outside-world information 11B of the sensor unit 140.

Furthermore, in the present embodiments described above, the case where the mobile body 100 changes the characteristics of the contact portions 130 by feeding back the sound information regarding the mobile body 100 has been described, but the present invention is not limited thereto. For example, the mobile body 100 may change the characteristics of the contact portions 130 of the leg portions 120 using a jamming mechanism. For example, the mobile body 100 may be configured such that the contact portions 130 are formed of a filling member or the like, and the pressure of a gas inside is changed to change the characteristics of the contact portions 130. For example, the mobile body 100 may have a configuration in which the contact portions 130 are detachable from the leg portions 120, and the plurality of contact portions 130 having different characteristics may be selectively attached to the leg portions 120. In this case, the control device 10 may be configured to instruct, for example, the mobile body 100, a human, or the like, the contact portions 130 to be attached to the leg portions 120.
(Effects)

The control device 10 includes the acquisition unit 12 that acquires the outside-world information 11B around the mobile body 100, and the control unit 13 that performs control to switch characteristics of the contact portions 130 in which characteristics of portions where the leg portions 120 of the mobile body 100 come into contact with the external environment 500 are switchable on the basis of the outside-world information 11B so that a contact sound between the contact portions 130 and the external environment 500 changes.

As a result, the control device 10 switches the characteristics of the contact portions 130 such that the contact sound between the contact portions 130 of the leg portions 120 and the external environment 500 changes on the basis of the acquired outside-world information 11B. As a result, the control device 10 switches the characteristics of the contact portions 130 of the leg portions 120 according to the surrounding situation and the like, so that the contact sound between the leg portions 120 and the external environment 500 can be changed. As a result, the control device 10 can support coexistence of the mobile body 100 and a human by changing the landing sound of the leg portions 120 of the mobile body 100 according to the external environment 500.

In the control device 10, the acquisition unit 12 acquires the outside-world information 11B including the environmental sound around the mobile body 100, and the control unit 13 performs control to switch the characteristics of the contact portions 130 on the basis of the environmental sound.

As a result, the control device 10 can acquire the outside-world information 11B including the environmental sound around the mobile body 100 and switch the characteristics of the contact portions 130 of the leg portions 120 on the basis of the environmental sound. As a result, since the control device 10 can improve the accuracy of recognizing the surrounding environment in the environmental sound, it is possible to suppress the generation of a noise due to the landing sound of the leg portions 120 of the mobile body 100 with high accuracy.

In the control device 10, the control unit 13 performs control to switch the characteristics of the contact portions 130 on the basis of the environmental sound acquired at the second timing different from the first timing at which the leg portions 120 and the external environment 500 come into contact with each other.

As a result, the control device 10 can switch the characteristics of the contact portions 130 of the leg portions 120 based on the environmental sound excluding the landing sound. As a result, since the control device 10 can improve the accuracy of detecting the environmental sound, it is possible to further suppress the generation of a noise due to the landing sound of the leg portions 120 of the mobile body 100.

In the control device 10, the control unit 13 classifies types of the environmental sound and performs control to switch the characteristics of the contact portions 130 on the basis of the classified types of the environmental sound.

As a result, the control device 10 can switch the characteristics of the contact portions 130 of the leg portions 120 according to the type of the environmental sound. As a result, since the control device 10 can switch to the characteristics of the contact portions 130 according to the type of the environmental sound, it is possible to support walking of the mobile body 100 suitable for the surrounding environment.

In the control device 10, in a case where the environmental sound includes a human voice, when the voice includes a voice requiring silence, the control unit 13 performs control to switch the characteristics of the contact portions 130 so that the contact sound becomes smaller.

As a result, when a human is requesting silence by utterance, the control device 10 can switch the characteristics of the contact portions 130 such that the contact sound between the leg portions 120 and the external environment 50 becomes smaller. As a result, the control device 10 can support coexistence of the mobile body 100 and a human by switching the characteristics of the contact portions 130 in response to a request for silence.

In the control device 10, the control unit 13 performs control to change at least one of an operation and a gait when the leg portions 120 come into contact with the external environment 500 on the basis of the outside-world information 11B.

As a result, the control device 10 can change at least one of the operation and the gait of the mobile body 100 in addition to switching the characteristics of the contact portions 130 on the basis of the outside-world information 11B. As a result, by changing the operation and the gait of the mobile body 100, the control device 10 can improve noise reduction as compared with the case of changing only the characteristics of the contact portions 130.

In the control device 10, the control unit 13 performs control to change the speed and the acceleration when the leg portions 120 come into contact with the external environment 500 on the basis of the outside-world information 11B.

As a result, the control device 10 can change the speed and acceleration of the leg portions 120 at the time of landing in addition to switching the characteristics of the contact portions 130 on the basis of the outside-world information 11B. As a result, the control device 10 can achieve noise reduction according to the external environment 500 by changing the landing sound of the leg portions 120 at the time of landing.

In the control device 10, the control unit 13 performs control to change the gait of the leg portions 120 on the basis of the outside-world information 11B so that the contact sound between the contact portions 130 and the external environment 500 changes.

As a result, the control device 10 can change the gait of the leg portions 120 so that the contact sound with the external environment 500 changes on the basis of the outside-world information 11B. As a result, the control device 10 can support coexistence of the mobile body 100 and a human by changing the contact sound of the contact portions 130 according to the gait of the mobile body 100.

In the control device 10, the control unit 13 performs control to switch the characteristics of the contact portions 130 on the basis of the difference between the landing sound of the leg portions 120 and the environmental sound according to the characteristics of the plurality of contact portions 130.

As a result, the control device 10 can switch the characteristics of the contact portions 130 on the basis of a result of machine learning of the difference between the landing sound of the leg portions 120 and the environmental sound, and the like. As a result, the control device 10 can switch to the characteristics of the contact portions 130 suitable for the landing sound of the leg portions 120 and the environmental sound, which can contribute to further noise reduction of the leg portions 120.

In the control device 10, the acquisition unit 12 acquires imaging information obtained by imaging the environment in which the mobile body 100 moves, and the control unit 13 performs control to switch the characteristics of the contact portions 130 on the basis of the environmental sound and the imaging information.

As a result, the control device 10 can switch the characteristics of the contact portions 130 according to the situation around the mobile body 100 indicated by the environmental sound and the imaging information. As a result, the control device 10 can change the characteristics of the contact portions 130 according to a road surface condition of the mobile body 100 and the like, so that it is possible to suppress a decrease in the mobility of the leg portions 120 and to support coexistence of the mobile body 100 and a human.

The mobile body 100 includes the plurality of leg portions 120, the contact portions 130 provided at portions where the leg portions 120 are in contact with the external environment 500 and switchable to a plurality of characteristics, and the control device 10 that controls the leg portions 120. The control device 10 includes the acquisition unit 12 that acquires the outside-world information 11B around the mobile body 100, and the control unit 13 that performs control to switch characteristics of the contact portions 130 in which characteristics of portions where the leg portions 120 of the mobile body 100 come into contact with the external environment 500 are switchable on the basis of the outside-world information 11B so that a contact sound between the contact portions 130 and the external environment 500 changes.

As a result, the mobile body 100 switches the characteristics of the contact portions 130 such that the contact sound between the contact portions 130 of the leg portions 120 and the external environment 500 changes on the basis of the acquired outside-world information 11B. As a result, since the mobile body 100 switches the characteristics of the contact portions 130 of the leg portions 120 according to the surrounding situation and the like, the contact sound between the leg portions 120 and the external environment 500 can be changed. As a result, the mobile body 100 can suppress the occurrence of problems due to coexistence with a human by changing the landing sound of the leg portions 120 according to the external environment.

In the mobile body 100, the contact portion 130 includes the plurality of elastic members 131 having different elastic moduli, and positions the elastic member 131 to be brought into contact with the external environment 500 among the plurality of elastic members 131 at the contact position.

As a result, the mobile body 100 can switch the plurality of elastic members 131 to come into contact with the external environment 500. As a result, in the mobile body 100, since the characteristics of the contact portions 130 provided in the leg portions 120 can be changed, noise reduction at the time of contact between the leg portions 120 and the external environment can be improved.

In the mobile body 100, the contact portion 130 changes the characteristics of the contact portion 130 based on the contact area between the elastic member 131 and the external environment 500.

As a result, the mobile body 100 can change the characteristics of the contact portion 130 by changing the contact area between the elastic member 131 and the external environment 500. For example, by forming the contact portion 130 in an elliptical columnar shape, the characteristics can be easily changed depending on the external environment 500 and the contact area. As a result, since the mobile body 100 can suppress an increase in the type of the elastic member 131 used for the contact portion 130, it is possible to reduce the cost of the contact portion 130 and improve noise reduction at the time of contact between the leg portions 120 and the external environment.

A control method, by a computer, includes acquiring the outside-world information 11B around the mobile body 100, and performing control to switch characteristics of contact portions 130 in which characteristics of portions where leg portions 120 of the mobile body 100 come into contact with the external environment 500 are switchable on the basis of the outside-world information 11B such that a contact sound between the contact portions 130 and the external environment 500 changes.

As a result, the control method switches the characteristics of the contact portions 130 such that the contact sound between the contact portions 130 of the leg portions 120 and the external environment 500 changes on the basis of the outside-world information 11B acquired by the computer. As a result, in the control method, since the characteristics of the contact portions 130 of the leg portions 120 are switched according to the surrounding situation and the like, the contact sound between the leg portions 120 and the external environment 500 can be changed. As a result, the control method can support coexistence of the mobile body 100 and a human by changing the landing sound of the leg portions 120 of the mobile body 100 according to the external environment.

Note that the following configurations also belong to the technical scope of the present disclosure.
(1)

A control device comprising:

an acquisition unit that acquires outside-world information around a mobile body; and

a control unit that performs control to switch characteristics of a contact portion capable of switching characteristics of a portion where a leg portion of the mobile body comes into contact with an external environment based on the outside-world information such that a contact sound between the contact portion and the external environment changes.
(2)

The control device according to (1), wherein

the acquisition unit acquires the outside-world information including an environmental sound around the mobile body, and

the control unit performs control to switch characteristics of the contact portion based on the environmental sound.
(3)

The control device according to (2), wherein

the control unit performs control to switch characteristics of the contact portion based on the environmental sound acquired at a second timing different from a first timing at which the leg portion and the external environment come into contact with each other.
(4)

The control device according to (2) or (3), wherein the control unit classifies types of the environmental sound and performs control to switch characteristics of the contact portion based on the classified types of the environmental sound.
(5)

The control device according to any one of (2) to (4), wherein

in a case where the environmental sound includes a voice of a human, when the voice includes a voice requiring silence, the control unit performs control to switch characteristics of the contact portion so that the contact sound becomes smaller.
(6)

The control device according to any one of (2) to (5), wherein

the control unit performs, based on the outside-world information, control to change at least one of an operation and a gait when the leg portion comes into contact with the external environment.
(7)

The control device according to (6), wherein the control unit performs, based on the outside-world information, control to change a speed and an acceleration when the leg portion comes into contact with the external environment.
(8)

The control device according to (6) or (7), wherein

the control unit performs control to change the gait of the leg portion based on the outside-world information so that the contact sound between the contact portion and the external environment changes.
(9)

The control device according to any one of (2) to (8), wherein

the control unit performs control to switch characteristics of the contact portion based on a difference between a landing sound of the leg portion and the environmental sound according to a plurality of characteristics.
(10)

The control device according to any one of (2) to (9), wherein

the acquisition unit acquires imaging information obtained by imaging an environment in which the mobile body moves, and

the control unit performs control to switch characteristics of the contact portion based on the environmental sound and the imaging information.
(11)

A mobile body comprising:

a plurality of leg portions;

contact portions provided at portions where the leg portions are in contact with an external environment, the contact portions being switchable between a plurality of characteristics; and

a control device that controls the leg portions, wherein

the control device includes:

an acquisition unit that acquires outside-world information around the mobile body; and

a control unit that performs control to switch characteristics of the contact portions based on the outside-world information such that a contact sound between the contact portions and the external environment changes.
(12)

The mobile body according to (11), wherein

the contact portions each include a plurality of elastic members having different elastic moduli, and position, at contact positions, the elastic members to be brought into contact with the external environment among the plurality of the elastic members.
(13)

The mobile body according to (12), wherein

the contact portions each change characteristics of the contact portions based on contact areas between the elastic members and the external environment.
(14)

A control method, by a computer, comprising:

acquiring outside-world information around a mobile body; and

performing control to switch characteristics of a contact portion capable of switching characteristics of a portion where a leg portion of the mobile body comes into contact with an external environment based on the outside-world information such that a contact sound between the contact portion and the external environment changes.
(15)

A control program that causes a computer to realize:

acquiring outside-world information around a mobile body; and

performing control to switch characteristics of a contact portion capable of switching characteristics of a portion where a leg portion of the mobile body comes into contact with an external environment based on the outside-world information such that a contact sound between the contact portion and the external environment changes.

### REFERENCE SIGNS LIST

10 CONTROL DEVICE

11 STORAGE UNIT

11A SETTING INFORMATION

11B OUTSIDE-WORLD INFORMATION

11C DRIVE INFORMATION

12 ACQUISITION UNIT

13 CONTROL UNIT

100 MOBILE BODY

110 MAIN BODY

120 LEG PORTION

130 CONTACT PORTION

131 ELASTIC MEMBER

132 HOLDING MECHANISM

140 SENSOR UNIT

141 AUDITORY SENSOR

142 VISUAL SENSOR

500 EXTERNAL ENVIRONMENT

1. A control device comprising:
an acquisition unit that acquires outside-world information around a mobile body; and
a control unit that performs control to switch characteristics of a contact portion capable of switching characteristics of a portion where a leg portion of the mobile body comes into contact with an external environment based on the outside-world information such that a contact sound between the contact portion and the external environment changes.

2. The control device according to claim 1, wherein
the acquisition unit acquires the outside-world information including an environmental sound around the mobile body, and
the control unit performs control to switch characteristics of the contact portion based on the environmental sound.

3. The control device according to claim 2, wherein
the control unit performs control to switch characteristics of the contact portion based on the environmental sound acquired at a second timing different from a first timing at which the leg portion and the external environment come into contact with each other.

4. The control device according to claim 3, wherein
the control unit classifies types of the environmental sound and performs control to switch characteristics of the contact portion based on the classified types of the environmental sound.

5. The control device according to claim 4, wherein
in a case where the environmental sound includes a voice of a human, when the voice includes a voice requiring silence, the control unit performs control to switch characteristics of the contact portion so that the contact sound becomes smaller.

6. The control device according to claim 2, wherein
the control unit performs, based on the outside-world information, control to change at least one of an operation and a gait when the leg portion comes into contact with the external environment.

7. The control device according to claim 6, wherein
the control unit performs, based on the outside-world information, control to change a speed and an acceleration when the leg portion comes into contact with the external environment.

8. The control device according to claim 6, wherein
the control unit performs control to change the gait of the leg portion based on the outside-world information so that the contact sound between the contact portion and the external environment changes.

9. The control device according to claim 2, wherein
the control unit performs control to switch characteristics of the contact portion based on a difference between a landing sound of the leg portion and the environmental sound according to a plurality of characteristics.

10. The control device according to claim 2, wherein
the acquisition unit acquires imaging information obtained by imaging an environment in which the mobile body moves, and
the control unit performs control to switch characteristics of the contact portion based on the environmental sound and the imaging information.

11. A mobile body comprising:
a plurality of leg portions;
contact portions provided at portions where the leg portions are in contact with an external environment, the contact portions being switchable between a plurality of characteristics; and
a control device that controls the leg portions, wherein
the control device includes:
an acquisition unit that acquires outside-world information around the mobile body; and
a control unit that performs control to switch characteristics of the contact portions based on the outside-world information such that a contact sound between the contact portions and the external environment changes.

12. The mobile body according to claim 11, wherein
the contact portions each include a plurality of elastic members having different elastic moduli, and position, at contact positions, the elastic members to be brought into contact with the external environment among the plurality of the elastic members.

13. The mobile body according to claim 12, wherein
the contact portions each change characteristics of the contact portions based on contact areas between the elastic members and the external environment.

14. A control method, by a computer, comprising:
acquiring outside-world information around a mobile body; and
performing control to switch characteristics of a contact portion capable of switching characteristics of a portion where a leg portion of the mobile body comes into contact with an external environment based on the outside-world information such that a contact sound between the contact portion and the external environment changes.
